(19) United States
(12) Patent Application Publication
(10) Pub. No.: US 2025/0292232 A1
(43) Pub. Date: Sep. 18, 2025

(54) WALLET TO WALLET (W2W) PAYMENT SYSTEM

(71) Applicant: ADEL ALBAZEI, Riyadh (SA)

(72) Inventor: ADEL ALBAZEI, Riyadh (SA)

(21) Appl. No.: 18/606,536

(22) Filed: Mar. 15, 2024

(51) Int. Cl. G06Q 20/36; G06Q 20/32; G06Q 20/40

(52) U.S. Cl. CPC G06Q 20/36; G06Q 20/3278; G06Q 20/40145

(57) ABSTRACT

A money transfer method using the NFC technology in the electronic devices in which will decrease the using of the cash money in the daily routine and increase the security of the money transactions using several high security protocols and its characterized by: a NFC enabled electronic device (1); a biometric authentication (2) system build-in the electronic device (1); a server (4), that process the money transaction; and a database (5) which stores the transaction information.

### FIELD OF THE INVENTION

The present invention describes a money transfer method using NFC technology in the electronic devices in which will decrease the using of the cash money in the daily routine and increase the security of the money transactions using several high security protocols.

### BACKGROUND OF THE INVENTION

The history of money transfer and payment methods has indeed evolved through various phases, reflecting the advancements in technology, trade, and communication. Here's an overview of the key phases in the evolution of money transfer:

1. Barter System (Prehistoric Era): In the earliest stages of human civilization, people engaged in barter, exchanging goods and services directly without a standardized medium of exchange.

2. Commodity Money (Ancient Civilizations): As societies progressed, commodities like shells, salt, and precious metals (such as gold and silver) were used as a form of money.

3. Metal Coins (Ancient Greece and Rome): The use of metal coins emerged, providing a more standardized and convenient medium of exchange. Governments began minting coins with designated values.

4. Paper Money (China, 7th Century): China is credited with the invention of paper money during the Tang Dynasty. Paper currency provided a more lightweight and easily transportable alternative to metal coins.

5. Banknotes (17th Century Europe): In Europe, banks started issuing promissory notes,

which evolved into banknotes. These notes represented a promise to pay the bearer a specific amount of precious metal on demand.

6. Banking Systems and Checks (17th Century): Banks became central to the money transfer process. Checks, a form of written order to a bank to pay a specified sum, gained popularity, simplifying long-distance transactions.

7. Telegraph and Wire Transfers (19th Century): The telegraph facilitated the transfer of funds over long distances by encoding and transmitting messages. This marked the beginning of electronic money transfer.

8. Credit Cards (Mid-20th Century): The introduction of credit cards provided a convenient means of making payments without carrying physical cash. This innovation significantly transformed the payment landscape.

9. ATMs (1960s): Automated Teller Machines (ATMs) enabled individuals to access cash and conduct basic banking transactions outside of regular banking hours.

10. Online Banking (1990s): The rise of the internet led to the development of online banking, allowing users to check balances, transfer funds, and pay bills electronically.

11. Digital Wallets and Mobile Payments (21st Century): With the proliferation of smartphones, digital wallets and mobile payment apps emerged, enabling users to make transactions using their mobile devices.

12. Cryptocurrencies and Blockchain (2009 onwards): Bitcoin, introduced in 2009, ushered in the era of cryptocurrencies and blockchain technology. These decentralized systems offer new ways of transferring and storing value.

13. Contactless Payments and NFC (21st Century): Contactless payment methods, utilizing Near Field Communication (NFC) technology, allow users to make transactions by tapping their cards or mobile devices.

The ongoing evolution of money transfer and payment methods continues to be shaped by technological innovations, regulatory changes, and shifts in consumer behavior. These developments aim to make financial transactions more efficient, secure, and accessible.

Upon on going to the latest innovation of payment methods the (NFC) we concluded that a new revolutionized money transfer method should be invented. The new money transfer method will be described below.

### SUMMARY OF THE INVENTION

The invention involves a money transfer method that harnesses NFC technology for seamless and secure electronic transactions. Key features of the invention include:

The technology acts as a bank on its own, no need for any other bank or third party to act as the guarantor of the money. The system will be monitored by the countries central banks directly as the normal banks and all the money transfers will be done using the system without the need of any banking system. As an example of the invention there are several systems that works in this way such as: PayPal and STC pay.

NFC-enabled Devices: Utilizes electronic devices equipped with NFC capabilities, such as smartphones, tablets, or smartwatches. The system will be processing the transfer by tapping the electronic devices to the other electronic devices after adjusting the amount of money they want to transfer from the wallet to wallet application.

Secure Protocols: Implements robust security protocols to safeguard money transfers, including 256-bit AES encryption or higher, authentication, and authorization mechanisms using the biometrics of the user (finger print, eye print, face recognition and/or voice recognition or any other biometrics methods). With reference to our other patent application number WO2023128840 and titled “Unique Code”. All the w2w wallets will be connected to the user unique code in which will insure the user information are 100% correct and will increase the security of the money transfer system due to the fact that the unique code is issued to every single person separately and also the unique code is connected to the governments and to the central banks in which it helps the official people monitoring all the suspected transfers easily.

User Authentication: Incorporates user authentication methods, such as biometrics, PINs, or passwords, to ensure the legitimacy of transactions.

Transaction Authorization: A robust authentication process is implemented to verify the identities of the involved parties. This may include biometric authentication, digital signatures, or other secure means to ensure the legitimacy of the transaction.

Transaction Record Keeping: Financial data, including transaction amounts and participant details, is transmitted securely using encryption protocols. This prevents unauthorized interception and manipulation of sensitive information during the money transfer process.

Communication Protocols: Specifies communication protocols between NFC-enabled devices, financial institutions, and any intermediary systems involved in the transaction process.

Advantages:

Reduced Dependency on Physical Currency: The invention promotes a shift towards digital currency, reducing the need for physical cash in daily transactions.

Enhanced Security: The incorporation of advanced security protocols ensures a high level of security in electronic money transfers, particularly in B2B scenarios.

Convenience and Efficiency: NFC technology streamlines the money transfer process, providing a convenient and efficient means of conducting financial transactions.

### BRIEF DESCRIPTION OF THE DRAWINGS

FIG. 1 is a general depiction of how the electronic devices tap each other to do the money transfer.

FIG. 2 is a general depiction of how each person has a unique code (e.g., biometrics) connected to a server of the wallet system.

FIG. 3 is a general depiction of how the process happens and is archived in the servers.

### REFERENCE

1. Electronic Device

2. Biometric Authentication

3. User

4. Server

5. Database

### DETAILED DESCRIPTION OF THE INVENTION

The parts that make up the system mentioned in the invention are basically an electronic device (1), biometrics authentication (2), user (3), server (4) and database (5).

The invention revolutionizes the realm of electronic transactions by introducing a cutting-edge money transfer method that leverages Near Field Communication (NFC) technology. This innovative system eliminates the need for traditional banking intermediaries, acting as a standalone financial entity monitored directly by the country's central banks. The core features of the invention ensure seamless, secure, and efficient electronic transactions.

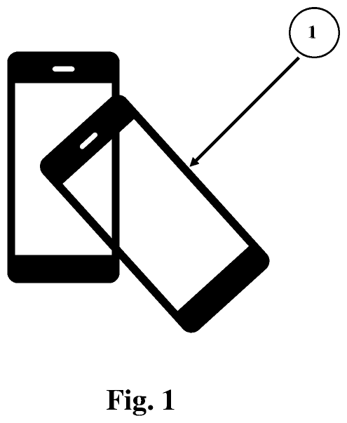

As shown in FIG. 1, the system harnesses the power of NFC-enabled devices, such as smartphones, tablets, and smartwatches, to facilitate money transfers. Users (3) can initiate transactions by tapping their electronic devices (1) together after specifying the desired transfer amount within a dedicated wallet-to-wallet application.

The autonomous nature of the system is a key differentiator. Users (3) can manage their finances independently without the need for traditional banks or intermediaries. The system is equipped to handle deposits, withdrawals, and transfers seamlessly, providing users (3) with greater control over their financial transactions.

Central banks directly monitor the system, just like they would with traditional banks. This direct oversight ensures regulatory compliance and enhances the system's transparency. Government authorities can access real-time data through the unique code system, allowing them to track and analyze financial transactions for any suspicious activities.

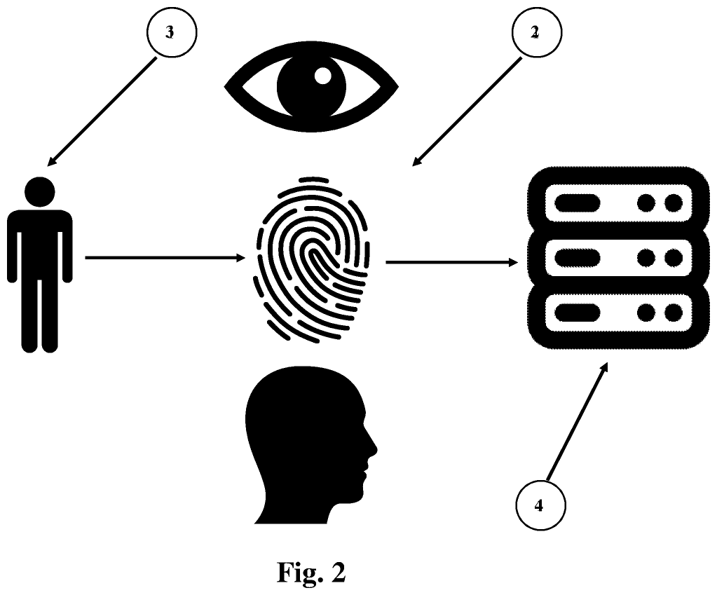

As shown in FIG. 2, the user biometric authentication (3) is a critical aspect of the system's security. The multi-layered biometric authentication (3) process includes fingerprint scans, eye prints, face recognition, and/or voice recognition. This comprehensive approach not only ensures the legitimacy of the user but also provides an additional layer of security against unauthorized access.

The unique code system, detailed in patent application WO2023128840, assigns a distinct code to each user. This code acts as a secure identifier and is directly connected to government databases and central banks. It not only enhances the accuracy of user information but also facilitates efficient tracking of transactions by authorized entities.

In addition to biometric authentication (2), users can employ PINs or passwords for added security. This dual authentication process ensures that even if one layer is compromised, there is an additional safeguard in place to protect the user's financial information.

Transactions are further secured through the use of digital signatures. This cryptographic technique ensures that the transaction has been authorized by the rightful owner of the funds. It adds an extra layer of security to the overall transaction process.

Financial data, including transaction amounts and participant details, is transmitted securely using advanced encryption protocols. This prevents any unauthorized interception or manipulation of sensitive information during the money transfer process, safeguarding user privacy and financial integrity.

While the transaction is being done, the transaction details and processing will be processed by a high encrypted server (4) which processes and deliver all of the transactions using the system and the algorithm uploaded to the server.

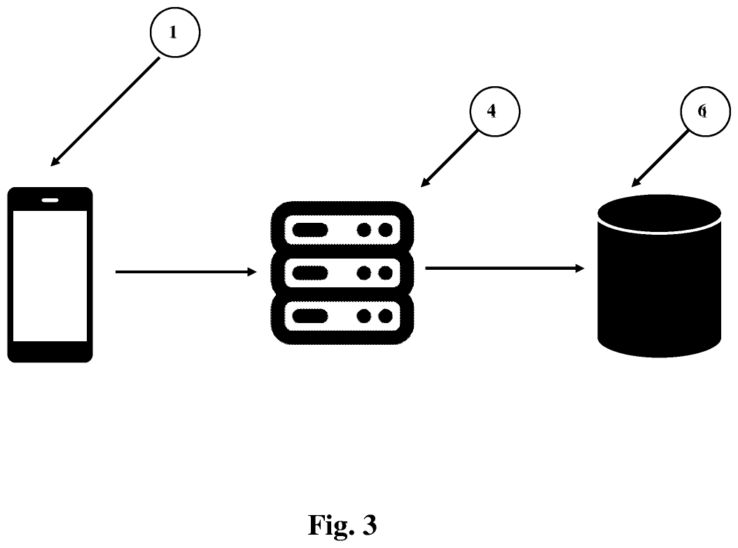

As shown in FIG. 3, after the transaction is done, all the information of the transaction will be stored in the database (5). The database is highly encrypted by using 256-bit AES encryption. The data uploaded on the database can be accessed by some government departments upon request and also by the county's central bank.

The system maintains real-time transaction records, including details such as transfer amounts, participant identities, and timestamps. This comprehensive record-keeping not only enhances transparency but also assists in resolving any disputes or discrepancies that may arise during the transaction process.

The system is designed to seamlessly integrate with existing financial infrastructures, allowing for interoperability with other payment systems and financial institutions. This ensures that users can transfer funds effortlessly, whether within the system or to external accounts.

What is claimed is:

1. A wallet to wallet (w2w) payment system for users, comprising:
a NFC enabled electronic device;
a biometric authentication system build-in the electronic device;
a server, that processes the money transaction; and
a database which stores the transaction information.

2. The system according to claim 1, wherein at least two devices tap each other to be able to fulfill the money transaction.

3. The system according to claim 1, wherein the biometric authentication system ensures that the transaction is done by an authorized person.

4. The system according to claim 1, wherein the server processes the transactions between users.

5. The system according to claim 1, wherein the database stores all the information of the users and transactions in detail.
